(19) United States
(12) Patent Application Publication
(10) Pub. No.: US 2010/0016476 A1
(43) Pub. Date: Jan. 21, 2010

(54) Cement Additive and Cement Composition Using the Same

(76) Inventors: Minoru Yaguchi, Kanagawa (JP); Takumi Sugamata, Kanagawa-Ken (JP); Takashi Kinoshita, Kanagawa-Ken (JP)

Correspondence Address: CURATOLO SIDOTI CO., LPA, 24500 CENTER RIDGE ROAD, SUITE 280, CLEVELAND, OH, 44145, US

(21) Appl. No.: 12/551,744

(22) Filed: Sep. 1, 2009

Related U.S. Application Data
(63) Continuation of application No. 12/094,331, filed on Aug. 7, 2008, now abandoned.

(30) Foreign Application Priority Data
Dec. 1, 2005 (JP) 2005-348253

(51) Int. Cl. C04B 16/04; C08K 5/06

(52) U.S. Cl. 524/5; 524/366

(57) ABSTRACT

A cement additive is provided which has a good autogenous shrinkage reducing effect and reduces the viscosity of concrete, and wherein compound A, which is a polycarboxylate copolymer, and ether compounds are indispensable components.

The invention relates to an additive for cement and a cement composition using the same.

In recent years, the use of high strength concrete, ultra high strength concrete and other types of high performance concrete has increased remarkably for applications in concrete constructions. The need for these types of concrete has increased due to the rapid progress in the technologies for constructing taller high rise buildings and achieving higher durability of concrete constructions, etc. The properties required of these types of high performance concrete include ease of handling during on-site operations, long-term durability, strength properties and economic efficiency.

To assure ease of handling during on-site operations, which is the workability (suitability for force feeding under pumping pressure and compactability) when placing concrete, it is important that concrete viscosity is not excessively high. When mixing high strength concrete, ultra high strength concrete and other types of high performance concrete, the water/binder ratio is extraordinarily low and the unit binder amount is high; therefore, the viscosity of the concrete is extremely high, which makes it difficult to handle during on-site operations and leads to problems with pump feeding and compacting operations; a method having good workability is required for easy handling during on-site operations even with concrete mixed with high unit binder amounts and low water/binder ratios.

Moreover, long-term durability is to assure the quality of concrete over the long term; in particular, the reduction of the autogenous shrinkage in high strength concrete and ultra high strength concrete, which hitherto did not present much of a problem, is a new issue that gives cause for concern. The principal cause for this is that, when mixing high strength concrete and ultra high strength concrete, the water/binder ratio is extraordinarily low; during the hardening process, the volume decreases due to the hydration reaction of the cement, which is the binder, and the fine mineral powder; which means that the phenomenon of shrinkage will occur not only under dry conditions, i.e., autogenous shrinkage occurs; this autogenous shrinkage induces the cracking of the concrete which in turn has a considerable impact on the long-term durability of concrete constructions.

Regarding strength properties and economic efficiency, there is the question of how to assure the design strength of concrete; this can be achieved by different techniques: the causes leading to a decrease in strength can be eliminated, or strength can be adjusted to a level above the desired strength by increasing it beforehand through a further reduction of the water/binder ratio.

Regarding the causes of the former, there is the problem of the decrease in strength caused by an increase in the amount of entrained air, and the decrease in strength through the addition of shrinkage reducing agents used for reducing autogenous shrinkage. Here, the principal causes for the increase in the amount of entrained air are the water reducing agent used and the use of a shrinkage reducing agent; in the before-mentioned types of high performance concrete, the added amount of these water reducing agents and shrinkage reducing agents is high, therefore, an excessive amount of air is entrained, which in turn leads to the problem of the decrease in strength; a method of controlling the amount of air by using a great amount of defoaming agent for reducing the amount of air is adopted even though it is very complicated to use. Further, the other principal cause, which is the decrease in strength through the addition of a shrinkage reducing agent, results from the fact that shrinkage reducing agents hamper the crystal growth of hydration products. Consequently, it is necessary to rigorously control the amount of entrained air in concrete and to reduce the quantity of the shrinkage reducing agent used. The latter is preferable from an economic point of view because of the dramatic increase of the material cost.

Conventional cement additives for controlling autogenous shrinkage in high strength concrete and ultra high strength concrete, etc., are known, wherein polycarboxylate compounds of copolymers of allyl ether to which maleic acid anhydride and polyoxyalkylene derivatives are added and onto which polyoxyalkylene derivatives are further graft polymerized (refer for example to Patent Document 1). However, in such polycarboxylate compounds, polyalkyleneimine derivatives are not used as constituent monomers, when said cement additives are used, it is not possible to obtain a sufficient autogenous shrinkage reducing effect, and there is the need to use large amounts of cement additive for obtaining a satisfactory autogenous shrinkage reducing effect. When using large amounts of cement additives to obtain an autogenous shrinkage reducing effect, it becomes extremely difficult to control the fluidity of the concrete. Moreover, the viscosity of the concrete will also be high, handling during operation becomes difficult, workability will decrease, and, in order to adjust the amount of entrained air, it becomes necessary to use a large amount of defoaming agent.

Furthermore, cement additives are known wherein, in proportion to the polycarboxylate compounds which are copolymers of allyl ether or methacrylic acid to which monocarboxylic acid or dicarboxylic acid and polyoxyalkylene derivatives are added, relatively large amounts of ether compounds are used as shrinkage reducing component (refer for example to Patent Document 2). However, in the polycarboxylate compounds used in these cement additives, polyalkyleneimine derivatives are not used as constituent monomers, and because, in proportion to the polycarboxylate compounds, relatively large amounts of ether compounds are used as shrinkage reducing component, there is the problem of an increase in the amount of entrained air and a decrease in strength due to the great amount of shrinkage reducing agent used. Moreover, when the water reducing properties are insufficient, even more cement additives need to be used, which leads to a further decrease in strength. And, from the viewpoint of workability and ease of handling of high strength concrete and ultra high strength concrete, neither is satisfactory.

Polycarboxylate copolymers using polyalkyleneimine monomers as constituent element are known as water reducing agents (refer for example to Patent Document 3), regarding which it is mentioned that fluidity and ease of handling can be improved in cement compositions with a low water/cement ratio; however, there is no disclosure whatsoever regarding the reduction of autogenous shrinkage in high strength concrete, and it is clear that, used on their own, an autogenous shrinkage reducing effect cannot be obtained, even though there is no mention nor suggestion whatsoever regarding their use together with an autogenous shrinkage reducing agent.

Thus, in the present situation, there is no cement additive for solving all the above-mentioned problems at once.

[Patent Document 1] JP (A) 2004-292283

[Patent Document 2] JP (A) 2001-302307

[Patent Document 3] JP (A) 2004-67934

### DISCLOSURE OF THE INVENTION

### Problems to be Solved by the Invention

Consequently, the object of the present invention is to provide a cement additive and a cement composition which excel in the strength properties and the autogenous shrinkage reducing properties required of cement compositions such as high strength concrete, ultra high strength concrete and other types of high performance concrete, which make possible a low viscosity for easy handling of the concrete, make it easy to adjust the amount of entrained air, and which are advantageous from an economic point of view.

### Means for Solving the Problems

The inventors of the present invention, as a result of having made extensive studies to solve the above problems, have found that, by combining a copolymer using allyl ether, methacrylic acid or other monomers having a polyalkyleneimine derivative as a side chain, as constituent component of the polycarboxylate copolymer and an ether compound having autogenous shrinkage reducing properties, not only the water reducing and strength properties are improved, but also the shrinkage reducing properties are increased more by the combined use than is the case when only the ether compound is used, and have thus completed the invention.

According to the present invention, satisfactory autogenous shrinkage reducing properties can be obtained by using small amounts of cement additive, and, without causing a decrease in the strength properties, concrete can be produced which has a low viscosity, is easy to handle and wherein excessive amounts of air are not entrained.

Thus, the invention is related to a cement additive for reducing autogenous shrinkage and solving the problem of the decrease in strength properties of high strength concrete, ultra high strength concrete, etc., and improving workability by reducing the viscosity of concrete, and making it easy to adjust the amount of entrained air.

The invention is related to a cement additive comprising polycarboxylate copolymers (compound A) and ether compounds (compound B) as indispensable components; wherein, said compound A is the polycarboxylate copolymer A-1 comprising an unsaturated carboxylate monomer (I) represented by formula (1), a polyoxyalkylene adduct monomer (II) which has an unsaturated group and is represented by formula (2) and/or formula (3), and a polyalkyleneimine monomer (III) which has an unsaturated group and is represented by formula (4) and/or formula (5) as indispensable constituent units, and wherein said compound B is an ether compound which has an oxyalkylene group and is represented by formula (6);

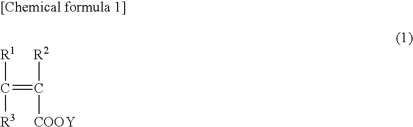

(wherein, R¹, R² and R³ each independently represent hydrogen, a methyl group or a —(CH₂) p COOX group, Y and X each independently represent hydrogen, an alkali metal, an alkaline earth metal, ammonium, alkyl ammonium or an alkyl group having 1 to 30 carbon atoms, p is an integer of 0 to 2);

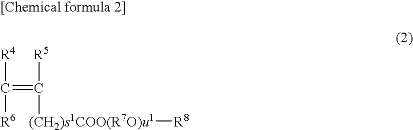

(wherein, R⁴, R⁵ and R⁶ each independently represent hydrogen or a methyl group, s¹ is an integer of 0 to 2, R⁷O represents one or more mixtures of oxyalkylene groups having 2 to 18 carbon atoms, u¹ represents the average addition mol number of the oxyalkylene group (R⁷O), which is a number of 1 to 100, R⁸ represents hydrogen or an alkyl group having 1 to 4 carbon atoms);

R⁹—O-(A¹)n¹-(R¹⁰O)u²-R¹¹ (3)

(wherein, R⁹ represents an alkenyl group having 2 to 5 carbon atoms, A¹ represents an alkylene group having 1 to 4 carbon atoms, n¹ is a number of 0 to 30, R¹⁰O represents an oxyalkylene group having 2 to 3 carbon atoms, u² represents the average addition mol number of the oxyalkylene group (R¹⁰O), which is a number of 1 to 100, R¹¹ represents hydrogen or an alkyl group having 1 to 4 carbon atoms),

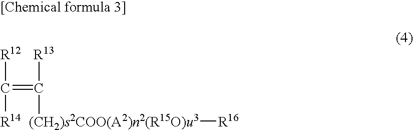

(wherein, R¹², R¹³ and R¹⁴ each independently represent hydrogen or a methyl group, s² is an integer of 0 to 2, A² represents alkyleneimine having 2 to 4 carbon atoms, n² is an integer of 1 to 30, R¹⁵O represents one or more mixtures of oxyalkylene groups having 2 to 18 carbon atoms, u³ represents the average addition mol number of the oxyalkylene group (R¹⁵O), which is a number of 1 to 100, R¹⁶ represents hydrogen of an alkyl group having 1 to 4 carbon atoms);

R¹⁷—O-(A³)n³-(A⁴)n⁴(R¹⁸O)u⁴-R¹⁹ (5)

(wherein, R¹⁷ represents an alkenyl group having 2 to 5 carbon atoms, A³ represents an alkylene group having 1 to 4 carbon atoms, n³-is an integer of 0 to 2, A⁴ represents an alkyleneimine group having 2 to 4 carbon atoms, n⁴ is 1 to 30, R¹⁸O represents an oxyalkylene group having 2 to 3 carbon atoms, u⁴ represents the average addition mol number of the oxyalkylene group (R¹⁸O), which is 1 to 100, R¹⁹ represents hydrogen or an alkyl group having 1 to 4 carbon atoms);

R²⁰O(R²¹O)n⁵H (6)

(wherein, R²⁰ represents hydrogen or an alkyl group having 1 to 8 carbon atoms, R²¹O represents an oxyalkylene group having 2 to 3 carbon atoms, n⁵ represents the average addition mol number of the oxyalkylene group (R²¹O), which is a number of 1 to 10).

The invention is further related to the above-mentioned cement additive, wherein the polycarboxylate copolymers (compound A) further comprise polycarboxylate copolymer A-2 which comprises an unsaturated carboxylate monomers (I) represented by formula (1), a polyoxyalkylene adduct monomer (II) which has an unsaturated group and is represented by formula (2) and/or formula (3) as indispensable constituent units.

The invention is also related to the above mentioned cement additives, wherein the mixing ratio of copolymer A-1 and copolymer A-2 in the polycarboxylate copolymer (compound A) is A-1:A-2=100-50:0-50 percent by mass.

The invention is further related to the above-mentioned cement additives, wherein the amount of the unsaturated carboxylate monomer (I) which is an indispensable constituent unit of copolymers A-1 and A-2 is, in each copolymer, 15 to 50 percent by mass.

The invention is also related to the above-mentioned cement additives wherein the mixing ratio of compounds A and B is compound A:compound B=60-95:40-5 percent by mass.

The invention is further related to the above-mentioned cement additives, wherein the respective average molecular weight of compound A-1 and compound A-2 is 5,000 to 50,000.

The invention is also related to the above-mentioned cement additives, wherein, in copolymer A-1 and/or copolymer A-2, the unsaturated carboxylate monomer (I) is methacrylic acid and/or a salt thereof and the unsaturated polyoxyalkylene adduct monomer (II) is a polyoxyalkylene esterification product of methacrylic acid.

The invention is further related to the above mentioned cement additives, wherein, in compound B represented by formula (6), R²⁰ is hydrogen or an alkyl group having 2 to 4 carbon atoms, with the proviso that, when R²⁰ is hydrogen, R²¹O is propylene oxide, n⁵ is 2 to 9, and when R²⁰ is an alkyl group having 2 to 4 carbon atoms, R²¹O is ethylene oxide and n⁵ is 1 to 4, or R²¹O is propylene oxide and n⁵ is 2 to 9, or R²¹O is a mixture of ethylene oxide and propylene oxide, while n⁵ is 2 to 9.

The invention is also related to a cement composition comprising water, a binder and any of the above-mentioned cement additives, wherein the water/binder ratio is 30 percent or less, and wherein the binder is cement or a mixture of cement and fine hydraulic powder, and the added amount of said cement additive is 0.1 to 1.5 percent of the binder mass.

Regarding the ease of handling during on-site operations, the long-term durability, the strength properties and the economic efficiency required of high strength concrete and ultra high strength concrete, the cement additive according to the invention improves workability by a decrease in concrete viscosity and makes it possible to achieve autogenous shrinkage reducing properties without a loss in the strength properties.

### PREFERRED EMBODIMENTS OF THE INVENTION

The cement additive according to the present invention comprises as indispensable components polycarboxylate copolymers (compound A) which are made by mixing copolymer A-1 and copolymer A-2 which, respectively, have an average molecular weight of 5,000 to 50,000, and ether compounds (compound B); and wherein the constituent ratio of compound A:compound B=60-95:40-5 percent by mass. Moreover, compound A is mixed in a ratio of A-1:A-2=100-50:0-50 percent by mass; said copolymer A-1 is a polycarboxylate copolymer comprising an unsaturated carboxylate monomer (I) represented by formula (1), an unsaturated polyoxyalkylene adduct monomer (II) represented by formula (2) and/or formula (3), and a polyalkyleneimine monomer (III) which has an unsaturated group and is represented by formula (4) and/or formula (5) as indispensable constituent units, and copolymer A-2 is a polycarboxylate copolymer comprising an unsaturated carboxylate monomer (I) represented by formula (1) and a polyoxyalkylene adduct monomer (II) which has an unsaturated group and is represented by formula (2) and/or formula (3) as indispensable constituent units. In copolymers A-1 and A-2 the amount of the unsaturated carboxylate monomer (I) is 15 to 50 percent by mass of the copolymer; and compound B is an ether compound which has an oxyalkylene group and is represented by formula (6).

The above is a cement additive wherein the unsaturated carboxylate monomer (I) of compound A-1 and/or compound A-2 is methacrylic acid and/or a salt thereof, the unsaturated polyoxyalkylene adduct monomer (II) of compound A-1 and/or compound A-2 is a polyoxyalkylene esterification product of methacrylic acid; characterized in that the before-mentioned compound B is an ether compound which has an oxyalkylene group and is represented by formula (7), the unsaturated carboxylate monomer (I) of the before-mentioned compound A-1 and/or compound A-2 is methacrylic acid and/or a salt thereof, the unsaturated polyoxyalkylene adduct monomer (II) of compound A-1 and/or compound A-2 is a polyoxyalkylene esterification product of methacrylic acid, the before mentioned compound B is an ether compound which has an oxyalkylene group and is represented by formula (6); characterized in that R²⁰ is hydrogen or an alkyl group having 2 to 4 carbon atoms, with the proviso that when, R²⁰ is hydrogen, R²¹O is propylene oxide, n⁵ is 2 to 9, and when R²⁰ is an alkyl group having 2 to 4 carbon atoms, R²¹O is ethylene oxide and n⁵ is 1 to 4, or R²¹O is propylene oxide and n⁵ is 2 to 9, or R²¹O is a mixture of ethylene oxide and propylene oxide, while n⁵ is 2 to 9. The cement composition according to the present invention comprises water, a binder and the before-mentioned cement additive, wherein the water/binder ratio is 30 percent or less, and wherein the binder is cement or cement and fine hydraulic powder, and the added amount of said cement additive is 0.1 percent to 1.5 percent of the binder mass.

According to the present invention formula 1 is:

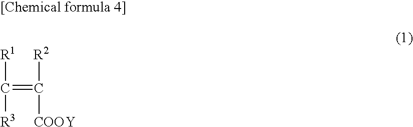

(wherein, R¹, R² and R³ each independently represent hydrogen, a methyl group or a —(CH₂) p COOX group, Y and X each independently represent hydrogen, an alkali metal, an alkaline earth metal, ammonium, alkyl ammonium or an alkyl group having 1 to 30 carbon atoms, p is an integer of 0 to 2);
formula 2 is:

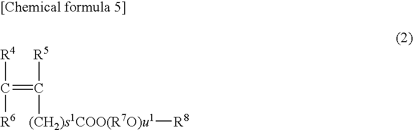

(wherein, R⁴, R⁵ and R⁶ each independently represent hydrogen or a methyl group, s¹ is an integer of 0 to 2, R⁷O represents one or more mixtures of oxyalkylene groups having 2 to 18 carbon atoms, u¹ represents the average addition mol number of the oxyalkylene group (R⁷O), which is a number of 1 to 100, R⁸ represents hydrogen or an alkyl group having 1 to 4 carbon atoms);
formula 3 is:

R⁹—O-(A¹)n¹-(R¹⁰O)u²-R¹¹ (3)

(wherein, R⁹ represents an alkenyl group having 2 to 5 carbon atoms, A¹ represents an alkylene group having 1 to 4 carbon atoms, n¹ is a number of 0 to 30, R¹⁰O represents an oxyalkylene group having 2 to 3 carbon atoms, u² represents the average addition mol number of the oxyalkylene group (R¹⁰O), which is a number of 1 to 100, R¹¹ represents hydrogen or an alkyl group having 1 to 4 carbon atoms);
formula 4 is:

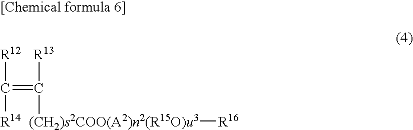

(wherein, R¹², R¹³ and R¹⁴ each independently represent hydrogen or a methyl group, s² is an integer of 0 to 2, A² represents alkyleneimine having 2 to 4 carbon atoms, n³ is an integer of 1 to 30, R¹⁵O represents one or more mixtures of oxyalkylene groups having 2 to 18 carbon atoms, u³ represents the average addition mol number of the oxyalkylene group (R¹⁵O), which is a number of 1 to 100, R¹⁶ represents hydrogen of an alkyl group having 1 to 4 carbon atoms);
formula 5 is:

R¹⁷—O-(A³)n³-(A⁴)n⁴(R¹⁸O)u⁴-R¹⁹ (5)

(wherein, R¹⁷ represents an alkenyl group having 2 to 5 carbon atoms, A³ represents an alkylene group having 1 to 4 carbon atoms, n³-is an integer of 0 to 2, A⁴ represents an alkyleneimine group having 2 to 4 carbon atoms, n⁴ is 1 to 30, R¹⁸O represents an oxyalkylene group having 2 to 3 carbon atoms, u⁴ represents the average addition mol number of the oxyalkylene group (R¹⁸O), which is 1 to 100, R¹⁹ represents hydrogen or an alkyl group having 1 to 4 carbon atoms);
and formula 6 is:

R²⁰O(R²¹O)n⁵H (6)

(wherein, R²⁰ represents hydrogen or an alkyl group having 1 to 8 carbon atoms, R²¹O is an oxyalkylene group having 2 to 3 carbon atoms, n⁵ represents the average addition mol number of the oxyalkylene group (R²¹O), which is a number of 1 to 10).

Specific examples of the unsaturated carboxylate monomer (I) used in copolymer A-1 and copolymer A-2 according to the present invention, which may be identical or different, include acrylic acids, methacrylic acids, maleic acids or alkyl ethers thereof, alkali metals, alkaline earth metals and ammonium or alkyl ammonium salts; while methacrylic acids and acrylic acids or salts thereof are preferred, and methacrylic acids or salts thereof are particularly preferred.

In copolymers A-1 and A-2, the amount of the unsaturated carboxylate monomer (I) is preferably 15 to 50 percent by mass of the copolymer, and particularly preferably 20 to 40 percent by mass. This range is preferred because, when the amount of the unsaturated carboxylate monomer (I) is 15 percent by mass or more, it is possible to produce a concrete having a prescribed fluidity wherein the water reducing properties of low water/binder ratios are sufficiently manifest; whereas when the amount is 50 percent by mass or less, it is possible to produce a desired concrete wherein the retardation of the setting time and the drop in strength development properties is controlled.

Examples of the polyoxyalkylene adduct monomer (II) having an unsaturated group, which is used in copolymers A-1 and A-2 according to the present invention, include polyoxyalkylene adducts of acrylic acid, polyoxyalkylene adducts of methacrylic acid, polyoxyalkylene adducts of maleic acid and polyoxyalkylene allyl ether. Preferred polyoxyalkylene derivatives added to the side chain are, of the compounds represented by formula (2), oxyalkylene derivatives having 2 to 18 carbon atoms; derivatives adding oxyalkylene groups having a different number of carbon atoms may also be used. Oxyalkylene derivatives having 2 to 3 carbon atoms are preferred, oxyethylene groups are most preferred. The addition number is 1 to 100, and preferably 5 to 50. Of the compounds represented by formula (3), oxyalkylene derivatives having 2 to 3 carbon atoms are preferred as adduct, oxyethylene groups are preferred. The addition number is 1 to 100, and preferably 5 to 50. Specific examples include one or more of methoxypolyethylene glycol acrylate (6EO), methoxypolyethylene glycol methacrylate (12EO), methoxypolyethylene glycol methacrylate (25EO), methoxypolyethylene glycol methacrylate (50EO), methoxypolyethylene glycol methacrylate (85EO), methoxypolyethylene glycol-polypropylene glycol methacrylate (12EO-2PO), methoxypolyethylene glycol-methallyl carboxylate (25EO), butoxypolyethylene glycol methacrylate (30EO), butoxypolyethylene glycol allyl ether (30EO), butoxypolyethylene glycol (20EO) vinyl ether, methoxypolypropylene glycol methacrylate (6EO) and methoxypropylene glycol allyl ether (6EO); preferred examples are one or more of methoxypolyethylene glycol methacrylate (12EO), methoxypolyethylene glycol methacrylate (25EO) and methoxypolyethylene glycol methacrylate (50EO).

Specific examples of the polyalkyleneimine monomer (III) having an unsaturated group, which is used in copolymer A-1 according to the present invention, include polyalkyleneimine derivative adducts of acrylic acid, polyalkyleneimine derivative adducts of methacrylic acid, polyalkyleneimine derivative adducts of maleic acid and polyalkyleneimine derivative allyl ether.

Examples of polyalkyleneimine derivatives for adding to the side chain are, of the compounds represented by formula (4), derivatives having alkyleneimine groups of 2 to 4 carbon atoms and derivatives having oxyalkylene groups of 2 to 18 carbon atoms. Alkyleneimine groups with 2 to 3 carbon atoms and oxyalkylene groups with 2 to 3 carbon atoms are preferred. Most preferred are combinations of ethyleneimine and oxyethylene groups. The addition number of the alkyleneimine group is 1 to 30 and the addition number of the oxyalkylene group is 1 to 100. The preferred addition number of the alkyleneimine group is 5 to 15 and the preferred addition number of the oxyalkylene group is 5 to 50. Of the compounds expressed by formula (5), these are those with alkyleneimine groups having 2 to 4 carbon atoms and oxyalkylene groups having 2 to 3 carbon atoms, respectively. Ethyleneimine groups and oxyethylene groups are preferred. The addition number of the alkyleneimine groups is 1 to 30 and the addition number of the oxyalkylene groups is 1 to 100; the preferred addition number of the alkyleneimine groups is 5 to 15 and the preferred addition number of the oxyalkylene groups is 5 to 50.

Specific examples include methoxypolyethylene glycol(4)-polyethyleneimine(10) acrylate, methoxypolyethylene glycol(4)-polyethyleneimine(10) methacrylate, methoxypolyethylene glycol(6)-polyethyleneimine(10) methacrylate, methoxypolyethylene glycol(8)-polyethyleneimine(25) methacrylate, methoxypolyethylene glycol(6)-polyethyleneimine(10) allyl ether; preferred examples are methoxypolyethylene glycol(4)-polyethyleneimine(10) methacrylate and methoxypolyethylene glycol(6)-polyethyleneimine(10) methacrylate.

The respective average molecular weight of compound A-1 and compound A-2 is preferably 5,000 to 50,000. This range is preferred because, when the average molecular weight is 5,000 or more, it is possible to produce a concrete having a prescribed fluidity wherein the water reducing properties of low water/binder ratios are sufficiently manifest, whereas when it is 50,000 or less, the viscosity of concrete is low, which makes it possible to produce concrete which is easy to handle on-site.

The mixing ratio of copolymers A-1 and A-2 are preferably 100-50:0-50 percent by mass. It is preferred to mix A-1 at a ratio of 50 percent by mass or more because, when it drops to below 50 percent by mass, it becomes difficult to maintain concrete viscosity at a low level.

Compound B according to the present invention is polyalkylene glycol or polyalkylene glycol alkyl ether; even though the oxyalkylene group is a group having 2 to 3 carbon atoms, oxyalkylene groups with a different number of carbon atoms may also be used. The addition number of the oxyalkylene group is 1 to 10; while, in the case of the oxypropylene group 2 to 9 is particularly preferred, and in the case of the oxyethylene group 1 to 4 is particularly preferred. The alkyl group added as ether having an oxypropylene group has 1 to 8 carbon atoms, and preferably 2 to 5 carbon atoms. Specific examples include polyethylene oxide (1EO) ethyl ether, polyethylene oxide (2EO) butyl ether, polyethylene oxide (5EO) butyl ether, polyethylene oxide (7EO) ethyl ether, polyethylene oxide (5EO) polypropylene oxide (2PO) butyl ether, polyethylene oxide (2EO) polypropylene oxide (2PO) butyl ether, polypropylene glycol (5PO) and polypropylene glycol (8PO); preferred are polyethylene oxide (1EO) ethyl ether, polyethylene oxide (2EO) butyl ether, polypropylene glycol (5PO), polypropylene glycol (8PO) and polyethylene oxide (2EO) polypropylene oxide (2PO) butyl ether.

The mixing ratio of compounds A and B is 60-95:40-5 percent by mass, particularly preferred is 70-85:30-15 percent by mass. This range is preferred because, when adding compound A at a ratio of 60 percent or more, it is possible to produce concrete having good workability and the prescribed fluidity at a low viscosity, and when adding compound B at a ratio of 5 percent or more an autogenous shrinkage reducing effect is manifest even at low water/binder ratios.

The cement composition according to the present invention, comprising water, a binder and a cement additive and wherein the water/binder ratio is 30 percent or less, is specifically advantageous in concrete of which an autogenous shrinkage reducing effect and a low viscosity are particularly required, especially when the water/binder ratio is 25 percent or less, and still more for water/binder ratios of 20 percent or less. The unit binder amount is at least 600 kg/m³; the binder, in particular, is cement or cement and fine hydraulic powder, while the cement is normal hydraulic cement. Examples include normal, early strength, high early strength, low heat, moderate heat, sulfate resistant, white and other types of Portland cement as well as blended cement, alumina cement and various other types of cement produced on the basis of fly ash. Fine hydraulic powder is silica fume, blast furnace and fused garbage slag and other types of fine powder as well as fine powder of lime stone, fly ash, gypsum and other types of fine mineral powder (a particle size of 0.1 μm to 300 μm is preferred); water that is normally used for producing concrete may be used without any particular limitations. Such water may for example be tap water, or other types of water (river water, lake water, well water, etc.) and recovered water specified in Annex 9 of JIS A 5308, etc. The aggregates normally used for producing concrete may also be used in the present invention without any particular limitations. Examples of such aggregates include for example river sand, pit sand, mountain sand, sea sand, crushed sand, river gravel, pit gravel, mountain gravel, crushed gravel, lightweight aggregate, heavyweight aggregate, slag aggregate, etc. In the present invention, the amount of aggregate in one cubic meter of concrete is not particularly limited; however, as a general rule it can for example be said that in the case of river sand, pit sand, mountain sand, sea sand, crushed sand, pit gravel, mountain gravel and crushed gravel, 600 to 3,000 kg are preferred.

The present invention is characterized in that the added amount of cement additive is 0.1 to 1.5 percent by mass of the total binder mass. When the added amount of cement additive is 0.1 percent by mass or more, it is possible to obtain a cement composition which is easy to handle during operations, has good strength properties and good autogenous shrinkage reducing properties; with added amounts of 1.5 percent by mass or more, it is not possible to obtain a better performance, therefore, from the economic point of view, it is preferred to use 1.5 percent by mass or less.

The production methods, methods of transportation, methods of placing the concrete, curing methods, etc., normally used for concrete compositions can be used without any particular limitations.

The cement additive according to the present invention is versatile, therefore other admixtures may be used as desired. Examples of other additives include the usual retardants, corrosion inhibitors, accelerators, rapid set accelerators and, according to the specified amount of entrained air, an AE agent, etc.

### EXAMPLES

Hereinafter, the present invention will be explained in greater detail, without however limiting the invention thereby to these embodiments.

Hereinafter, the present invention and compound A-1 used for the purpose of comparison are shown in Table 1.

TABLE 1
Compound A-1

| | | | | Mass |
|---|---|---|---|---|
| Compound | | | Mass | Av. Mol. |
| Type | Compound A-1 | | Ratio¹⁾ | Weight²⁾ |
| A-1-1 | Monomer (I) | Acrylic acid | 30 | 17,000 |
| | Monomer (II) | Methoxypolyethylene glycol | 50 | |
| | | methacrylate (25EO) | | |
| | Monomer (III) | Methoxypolyethylene glycol (4)- | 20 | |
| | | polyethyleneimine (10) | | |
| | | methacrylate | | |
| A-1-2 | Monomer (I) | Methacrylic acid | 30 | 19,000 |
| | Monomer (II) | Methoxypolyethylene glycol | 50 | |
| | | methacrylate (25EO) | | |
| | Monomer (III) | Methoxypolyethylene glycol (4)- | 20 | |
| | | polyethyleneimine (10) | | |
| | | methacrylate | | |
| A-1-3 | Monomer (I) | Methacrylic acid | 30 | 14,500 |
| | Monomer (II) | Methoxypolyethylene glycol | 50 | |
| | | methacrylate (12EO) | | |
| | Monomer (III) | Methoxypolyethylene glycol (6)- | 20 | |
| | | polyethyleneimine (10) | | |
| | | methacrylate | | |
| A-1-4 | Monomer (I) | Methacrylic acid | 30 | 15,000 |
| | Monomer (II) | Methoxypolyethylene glycol | 50 | |
| | | methacrylate (50EO) | | |
| | Monomer (III) | Methoxypolyethylene glycol (4)- | 20 | |
| | | polyethyleneimine (10) | | |
| | | methacrylate | | |
| A-1-5 | Monomer (I) | Methacrylic acid | 30 | 21,000 |
| | Monomer(II) | Methoxypolyethylene glycol | 50 | |
| | | methacrylate (80EO) | | |
| | Monomer (III) | Methoxypolyethylene glycol (4)- | 20 | |
| | | polyethyleneimine (10) | | |
| | | methacrylate | | |
| A-1-6 | Monomer (I) | Methacrylic acid | 50 | 17,500 |
| | Monomer (II) | Methoxypolyethylene glycol | 25 | |
| | | methacrylate (25EO) | | |
| | Monomer (III) | Methoxypolyethylene glycol (4)- | 25 | |
| | | polyethyleneimine (10) | | |
| | | methacrylate | | |
| A-1-7 | Monomer (I) | Methacrylic acid | 30 | 18,500 |
| | Monomer (II) | Methoxypolyoxyethylene allyl | 50 | |
| | | ether (25EO) | | |
| | Monomer (III) | Methoxypolyoxyethylene (6)- | 20 | |
| | | polyethyleneimine (10) allyl ether | | |

Notes:
¹⁾The ratio of monomers (I), (II) and (III) expressed in mass percentage.
²⁾The mass-average molecular weight was calculated by gel permeation chromatography (GPC) analysis converted into polyethylene glycol.
The measurements of the average molecular weight according to the present invention were conducted under the following condition: column: Shodex OH-pak SB-804 × 2, mobile phase: 0.1 mol Na₂SO₄, methanol/water = 20/80 percent by weight, temperature: 60° C., flow rate: 0.8 ml/min; without, however, limiting measurements according to the present invention to these parameters.

Hereinafter, the present invention and compound A-2 used for the purpose of comparison are shown in Table 2.

TABLE 2
Compound A-2

| | | | | Mass |
|---|---|---|---|---|
| Compound | | | Mass | Av. Mol. |
| Type | Compound A-2 | | Ratio¹⁾ | Weight²⁾ |
| A-2-1 | Monomer (I) | Acrylic acid | 30 | 13,000 |
| | Monomer (II) | Methoxypolyethylene glycol | 70 | |
| | | methacrylate (25EO) | | |
| A-2-2 | Monomer (I) | Methacrylic acid | 30 | 16,500 |
| | Monomer (II) | Methoxypolyethylene glycol | 70 | |
| | | methacrylate (6EO) | | |
| A-2-3 | Monomer (I) | Methacrylic acid | 30 | 12,000 |
| | Monomer (II) | Methoxypolyethylene glycol | 70 | |
| | | methacrylate (25EO) | | |
| A-2-4 | Monomer (I) | Methacrylic acid | 30 | 15,800 |
| | Monomer (II) | Methoxypolyethylene glycol | 70 | |
| | | methacrylate (50EO) | | |
| A-2-5 | Monomer (I) | Methacrylic acid | 30 | 19,200 |
| | Monomer (II) | Methoxypolyethylene glycol | 70 | |
| | | methacrylate (80EO) | | |
| A-2-6 | Monomer (I) | Methacrylic acid | 30 | 15,500 |
| | Monomer (II) | Butoxypolyethylene glycol | 70 | |
| | | methacrylate (30EO) | | |
| A-2-7 | Monomer (I) | Methacrylic acid | 30 | 26,800 |
| | Monomer (II) | Methoxypolyethylene glycol- | 70 | |
| | | polypropylene glycol methacrylate | | |
| | | (12EO-2PO) | | |
| A-2-8 | Monomer (I) | Maleic acid | 30 | 16,700 |
| | Monomer (II) | Methoxypolyethylene glycol | 70 | |
| | | methacrylate (25EO) | | |
| A-2-9 | Monomer (I) | Methacrylic acid | 50 | 17,000 |
| | Monomer (II) | Methoxypolyethylene glycol | 50 | |
| | | methacrylate (25EO) | | |
| A-2-10 | Monomer (I) | Methacrylic acid | 30 | 19,000 |
| | Monomer (II) | Methoxypolyoxyethylene allyl ether | 70 | |
| | | (25EO) | | |

Notes:
¹⁾The ratio of monomers (I) and (II) expressed in mass percentage.
²⁾The mass-average molecular weight was calculated by gel permeation chromatography (GPC) analysis converted into polyethylene glycol.
The measurements of the average molecular weight according to the present invention were conducted under the following condition: column: Shodex OH-pak SB-804 × 2, mobile phase: 0.1 mol Na₂SO₄, methanol/water = 20/80 percent by weight, temperature: 60° C., flow rate: 0.8 ml/min; without, however, limiting measurements according to the present invention to these parameters.

Hereinafter, the present invention and compound B used for the purpose of comparison are shown in Table 3.

TABLE 3
Compound B

| Compound | |
|---|---|
| Type | Compound B |
| B-1 | Polyethylene oxide (1EO) ethyl ether |
| B-2 | Polyethylene oxide (1EO) butyl ether |
| B-3 | Polypropylene glycol (5PO) |
| B-4 | Polypropylene glycol (8PO) |
| B-5 | Polyethylene oxide (2EO) polypropylene oxide (2PO) butyl |
| | ether |

Hereinafter, Examples and the constituent ratios of compounds A and B of the cement additive used as Comparative Examples are shown in Table 4.

TABLE 4
Cement Additives

| | Constituent Components of the Cement Additives | | | | Constituent Ratios of the | |
|---|---|---|---|---|---|---|
| Type of | Compound A | | Constituent Ratios of | | Compounds | |
| cement | Compounds | | Compounds A-1 and | | (mass %) | |
| additive | A-1 | A-2 | A-2 (mass %) | Compound B | Compound A | Compound B |
| Additive 1 | A-1-2 | A-2-1 | 70:30 | B-1 | 75 | 25 |
| Additive 2 | A-1-2 | A-2-2 | 70:30 | B-2 | 75 | 25 |
| Additive 3 | A-1-2 | A-2-3 | 70:30 | B-2 | 75 | 25 |
| Additive 4 | A-1-2 | A-2-4 | 70:30 | B-3 | 75 | 25 |
| Additive 5 | A-1-2 | A-2-5 | 70:30 | B-4 | 75 | 25 |
| Additive 6 | A-1-2 | A-2-6 | 70:30 | B-2 | 75 | 25 |
| Additive 7 | A-1-2 | A-2-7 | 70:30 | B-3 | 75 | 25 |
| Additive 8 | A-1-2 | A-2-8 | 70:30 | B-4 | 75 | 25 |
| Additive 9 | A-1-2 | A-2-9 | 70:30 | B-2 | 75 | 25 |
| Additive 10 | A-1-2 | A-2-10 | 70:30 | B-2 | 75 | 25 |
| Additive 11 | — | A-2-2 | 0:100 | B-2 | 75 | 25 |
| Additive 12 | A-1-2 | — | 100:0 | B-2 | 75 | 25 |
| Additive 13 | A-1-1 | A-2-2 | 70:30 | B-2 | 75 | 25 |
| Additive 14 | A-1-3 | A-2-2 | 70:30 | B-2 | 75 | 25 |
| Additive 15 | A-1-4 | A-2-2 | 70:30 | B-2 | 75 | 25 |
| Additive 16 | A-1-5 | A-2-2 | 70:30 | B-2 | 75 | 25 |
| Additive 17 | A-1-6 | A-2-2 | 70:30 | B-2 | 75 | 25 |
| Additive 18 | A-1-7 | A-2-2 | 70:30 | B-2 | 75 | 25 |
| Additive 19 | A-1-2 | A-2-2 | 55:45 | B-2 | 75 | 25 |
| Additive 20 | A-1-2 | A-2-2 | 70:30 | — | — | — |
| Additive 21 | A-1-2 | A-2-2 | 70:30 | B-2 | 30 | 70 |
| Additive 22 | A-1-2 | A-2-2 | 70:30 | B-5 | 75 | 25 |

The mix proportions of the concretes produced for confirming the effects of the present invention are shown in Tables 5 to 7.

TABLE 5
Concrete Mix Proportions

| | Unit Amount (kg/m³) | | | | |
|---|---|---|---|---|---|
| Water/binder | | | | Fine | Coarse |
| ratio (%) | Cement | Fly Ash | Water | Aggregate | Aggregate |
| 25.0 | 510 | 150 | 165 | 689 | 809 |

This cement is a low heat Portland cement.

TABLE 6
Concrete Mix Proportions

| | Unit Amount (kg/m³) | | | | |
|---|---|---|---|---|---|
| Water/binder | | Silica | | Fine | Coarse |
| ratio (%) | Cement | Fume | Water | Aggregate | Aggregate |
| 18.0 | 710 | 151 | 155 | 647 | 793 |

This cement is a low heat Portland cement.

TABLE 7
Concrete Mix Proportions

| | Unit Amount (kg/m³) | | | | |
|---|---|---|---|---|---|
| Water/binder | | Silica | | Fine | Coarse |
| ratio (%) | Cement | Fume | Water | Aggregate | Aggregate |
| 15.0 | 810 | 190 | 150 | 607 | 730 |

This cement is a low heat Portland cement.

### (Cement Production)

For producing a volume of 80 liters of cement with a target slump flow of 65±1.5 cm and a target amount of entrained air of 2.0±0.3 percent the different materials were weighed one after the other according to the proportions of Table 5. After introducing all the materials into a 100-liter pan-type forced kneading mixer, the concrete was produced by mixing the materials for 120 seconds.

Measurement of slump flow:
according to JIS A 1101
   Measurement of the air amount:
according to JIS A 1118
   Compression strength:
φ 10×20 cm test specimens were produced and measurements according to JIS A 1108 were conducted. Curing was conducted in standard water until the desired material age was obtained.

Measurement of the amount of autogenous shrinkage deformation:

The amount of autogenous shrinkage of concrete with the desired fluidity and a material age of 28 days was measured in a 10×10×40 cm steel frame according to the method of the Autogenous Shrinkage Research Committee Report (Japan Concrete Institute, 1996).

### (Evaluation of the Decrease in Concrete Viscosity)

The time to arrive at a flow of 50 cm, measured for the desired slump flow (65±1.5 cm), is:

| | |
|---|---|
| A (good): | 7 sec. or less, |
| B (normal): | 7 to 15 sec., and |
| C (bad): | 15 sec. or more. |

### (Evaluation of Air Entrainment)

Concrete wherein a water reducing agent is used that does not comprise a shrinkage reducing agent is compared with a reference concrete; the increase in the amount of entrained air is:

| | |
|---|---|
| A (very good): | 1 percent or more, |
| B (good): | 1 to 2 percent, |
| C (normal): | 2 to 5 percent, and |
| D (bad): | 5 percent or more. |

### (Evaluation of the Strength Properties)

Concrete wherein a water reducing agent is used that does not comprise a shrinkage reducing agent is compared with a reference concrete; compared to a reference concrete, the compressive strength ratio is:

| | |
|---|---|
| A (good): | 100 percent or more, |
| B (normal): | 80 to 100 percent, and |
| C (bad): | 80 percent or less. |

### (Evaluation of Autogenous Shrinkage Reducing Properties)

Concrete wherein a water reducing agent is used that does not comprise a shrinkage reducing agent is compared with a reference concrete; the ratio by which the amount of autogenous shrinkage is reduced is:

| | |
|---|---|
| A (very good): | 50 percent or more, |
| B (good): | 25 to 50 percent, |
| C (normal): | 10 to 25 percent, and |
| D (bad): | 10 percent or less. |

Hereinafter, the results for the different concrete mixtures confirming the effect of the present invention are shown in Tables 8, 10 and 11.

TABLE 8
The results for the different concrete mixtures (water/binder ratio: 25 percent)

| | | | | | | | | Autogenous | |
|---|---|---|---|---|---|---|---|---|---|
| | | | | | | Compressive | | Shrinkage | |
| | | Concrete | | Air | | Strength | | Reducing | |
| | | Viscosity | | Entrainment | | Properties | | Properties | |
| | Cement | Arrival at | | Amount | | Ratio | | Reduction | |
| | Additive | 60 cm | Eval. | (%) | Eval. | (%) | Eval. | Ratio (%) | Eval. |
| Reference Concrete¹⁾ | | 9.0 | B | 2.0 | — | Refer.²⁾ | — | Refer.³⁾ | — |
| Example 1 | Additive 1 | 8.9 | B | 2.1 | A | 100 | A | 53 | A |
| Example 2 | Additive 2 | 6.6 | A | 2.1 | A | 101 | A | 55 | A |
| Example 3 | Additive 3 | 6.4 | A | 2.1 | A | 101 | A | 55 | A |
| Example 4 | Additive 4 | 6.5 | A | 2.2 | A | 102 | A | 52 | A |
| Example 5 | Additive 5 | 6.8 | A | 2.3 | A | 104 | A | 53 | A |
| Example 6 | Additive 6 | 6.3 | A | 2.1 | A | 103 | A | 55 | A |
| Example 7 | Additive 7 | 6.4 | A | 2.0 | A | 100 | A | 54 | A |
| Example 8 | Additive 8 | 8.5 | B | 2.1 | A | 100 | A | 50 | A |
| Example 9 | Additive 9 | 6.6 | A | 2.1 | A | 102 | A | 54 | A |
| Example 10 | Additive 10 | 8.4 | B | 2.2 | A | 101 | A | 51 | A |
| Example 11 | Additive 12 | 6.0 | A | 2.1 | A | 108 | A | 63 | A |
| Example 12 | Additive 13 | 8.5 | B | 2.2 | A | 100 | A | 51 | A |
| Example 13 | Additive 14 | 6.6 | A | 2.3 | A | 103 | A | 54 | A |
| Example 14 | Additive 15 | 6.7 | A | 2.1 | A | 102 | A | 52 | A |
| Example 15 | Additive 16 | 6.7 | A | 2.3 | A | 105 | A | 53 | A |
| Example 16 | Additive 17 | 6.6 | A | 2.3 | A | 102 | A | 52 | A |
| Example 17 | Additive 18 | 9.1 | B | 2.4 | A | 102 | A | 53 | A |
| Example 18 | Additive 19 | 7.0 | A | 2.3 | A | 102 | A | 54 | A |
| Example 19 | Additive 22 | 6.5 | A | 2.3 | A | 102 | A | 48 | B |
| Comp. Ex. 1 | Additive 11 | 18.4 | C | 2.1 | A | 87 | B | 41 | B |
| Comp. Ex. 2 | Additive 20 | 6.8 | A | 2.4 | A | 100 | A | 0 | D |
| Comp. Ex. 3 | Additive 21 | 6.5 | A | 9.1 | D | 33 | D | 46 | B |
| Comp. Ex. 4 | Additive B | 9.2 | B | 7.2 | D | 48 | C | 37 | B |
| Comp. Ex. 5 | Additive C | 9.2 | B | 7.2 | D | 48 | C | 37 | B |
| Comp. Ex. 6 | Additive D | 10.1 | B | 2.1 | A | 87 | B | 12 | C |
| | 0.50% used | | | | | | | | |

The amount of additive used was 0.35 percent by mass in solid parts of the total mass of the binder (cement + fly ash).
Note:
¹⁾Additive A-2-2 was used in the reference concrete.
²⁾The compressive strength of the reference concrete with an age of 28 days was 105 N/mm².
³⁾The amount of autogenous shrinkage of the reference concrete was 560 μm.

Moreover, the compounds given in Table 9 were used as Additives B, C and D.

TABLE 9
Types of additives
Types of Additives

| | |
|---|---|
| Additive B | Cement additive E-2 according to JP (A) 2001-302307 |
| Additive C | Cement additive e-1 according to JP (A) 2001-302307 |
| Additive D | Graft copolymer 2 of the multi-functional cement dispersant |
| | according to JP (A) 2004-292283 |

TABLE 10
The results for the different concrete mixtures (water/binder ratio: 18 percent)

| | | | | | | | | Autogenous | |
|---|---|---|---|---|---|---|---|---|---|
| | | | | | | Compressive | | Shrinkage | |
| | | Concrete | | Air | | Strength | | Reducing | |
| | | Viscosity | | Entrainment | | Properties | | Properties | |
| | Cement | Arrival at | | Amount | | Ratio | | Reduction | |
| | Additive | 50 cm | Eval. | (%) | Eval. | (%) | Eval. | Ratio (%) | Eval. |
| Reference Concrete¹⁾ | | 9.5 | B | 2.1 | — | Refer.²⁾ | — | Refer.³⁾ | — |
| Example 20 | Additive 1 | 8.8 | B | 2.0 | A | 101 | A | 53 | A |
| Example 21 | Additive 2 | 6.6 | A | 2.1 | A | 101 | A | 54 | A |
| Example 22 | Additive 3 | 6.5 | A | 2.1 | A | 102 | A | 57 | A |
| Example 23 | Additive 4 | 6.8 | A | 2.2 | A | 102 | A | 52 | A |
| Example 24 | Additive 5 | 6.9 | A | 2.4 | A | 105 | A | 51 | A |
| Example 25 | Additive 6 | 6.5 | A | 2.1 | A | 103 | A | 58 | A |
| Example 26 | Additive 7 | 6.6 | A | 2.0 | A | 100 | A | 55 | A |
| Example 27 | Additive 8 | 8.8 | B | 2.1 | A | 100 | A | 51 | A |
| Example 28 | Additive 9 | 6.7 | A | 2.1 | A | 102 | A | 52 | A |
| Example 29 | Additive 10 | 8.5 | B | 2.2 | A | 101 | A | 52 | A |
| Example 30 | Additive 12 | 6.3 | A | 2.1 | A | 108 | A | 64 | A |
| Example 31 | Additive 13 | 8.8 | B | 2.2 | A | 100 | A | 50 | A |
| Example 32 | Additive 14 | 6.5 | A | 2.3 | A | 103 | A | 52 | A |
| Example 33 | Additive 15 | 6.7 | A | 2.1 | A | 102 | A | 53 | A |
| Example 34 | Additive 16 | 6.6 | A | 2.3 | A | 105 | A | 52 | A |
| Example 35 | Additive 17 | 6.7 | A | 2.3 | A | 102 | A | 52 | A |
| Example 36 | Additive 18 | 9.9 | B | 2.4 | A | 102 | A | 54 | A |
| Example 37 | Additive 19 | 7.0 | A | 2.3 | A | 102 | A | 53 | A |
| Example 38 | Additive 22 | 6.6 | A | 2.3 | A | 102 | A | 47 | B |
| Comp. Ex. 7 | Additive 11 | 19.5 | C | 2.1 | A | 87 | B | 42 | B |
| Comp. Ex. 8 | Additive 20 | 6.5 | A | 2.4 | A | 100 | A | 0 | D |
| Comp. Ex. 9 | Additive 21 | 6.8 | A | 9.1 | D | 33 | D | 44 | B |
| Comp. Ex. 10 | Additive B | 9.9 | B | 7.2 | D | 48 | C | 35 | B |
| Comp. Ex. 11 | Additive C | 9.9 | B | 7.2 | D | 48 | C | 35 | B |
| Comp. Ex. 12 | Additive D | 16.1 | D | 2.4 | A | 82 | B | 15 | C |
| | 0.65% used | | | | | | | | |

The amount of additive used was 0.45 percent by mass in solid parts of the total mass of the binder (cement + silica fume).
Note:
¹⁾Additive A-2-2 was used in the reference concrete.
²⁾The compressive strength of the reference concrete with an age of 28 days was 135 N/mm².
³⁾The amount of autogenous shrinkage of the reference concrete was 675 μm.

TABLE 11
The results for the different concrete mixtures (water/binder ratio: 15 percent)

| | | | | | | | | Autogenous | |
|---|---|---|---|---|---|---|---|---|---|
| | | | | | | Compressive | | Shrinkage | |
| | | Concrete | | Air | | Strength | | Reducing | |
| | | Viscosity | | Entrainment | | Properties | | Properties | |
| | Cement | Arrival at | | Amount | | Ratio | | Reduction | |
| | Additive | 50 cm | Eval. | (%) | Eval. | (%) | Eval. | Ratio (%) | Eval. |
| Reference Concrete¹⁾ | | 10.5 | B | 2.0 | — | Refer.²⁾ | — | Refer.³⁾ | — |
| Example 39 | Additive 1 | 9.3 | B | 2.1 | A | 100 | A | 51 | A |
| Example 40 | Additive 2 | 6.8 | A | 2.2 | A | 102 | A | 52 | A |
| Example 41 | Additive 3 | 6.9 | A | 2.1 | A | 102 | A | 53 | A |
| Example 42 | Additive 4 | 7.0 | A | 2.1 | A | 103 | A | 53 | A |
| Example 43 | Additive 5 | 7.0 | A | 2.3 | A | 104 | A | 52 | A |
| Example 44 | Additive 6 | 6.9 | A | 2.2 | A | 105 | A | 58 | A |
| Example 45 | Additive 7 | 6.9 | A | 2.1 | A | 102 | A | 53 | A |
| Example 46 | Additive 8 | 10.2 | B | 2.0 | A | 103 | A | 52 | A |
| Example 47 | Additive 9 | 6.9 | A | 2.0 | A | 103 | A | 52 | A |
| Example 48 | Additive 10 | 8.9 | B | 2.1 | A | 101 | A | 52 | A |
| Example 49 | Additive 12 | 6.7 | A | 2.3 | A | 105 | A | 57 | A |
| Example 50 | Additive 13 | 10.3 | B | 2.2 | A | 101 | A | 52 | A |
| Example 51 | Additive 14 | 6.8 | A | 2.3 | A | 102 | A | 51 | A |
| Example 52 | Additive 15 | 6.9 | A | 2.2 | A | 102 | A | 52 | A |
| Example 53 | Additive 16 | 7.0 | A | 2.2 | A | 106 | A | 53 | A |
| Example 54 | Additive 17 | 6.9 | A | 2.2 | A | 103 | A | 53 | A |
| Example 55 | Additive 18 | 11.2 | B | 2.3 | A | 103 | A | 52 | A |
| Example 56 | Additive 19 | 7.0 | A | 2.4 | A | 103 | A | 51 | A |
| Example 57 | Additive 22 | 6.9 | A | 2.2 | A | 103 | A | 45 | B |
| Comp. Ex. 13 | Additive 11 | 20.6 | C | 2.2 | A | 85 | B | 43 | B |
| Comp. Ex. 14 | Additive 20 | 6.9 | A | 2.2 | A | 101 | A | 0 | D |
| Comp. Ex. 15 | Additive 21 | 7.0 | A | 9.9 | D | 33 | D | 43 | B |
| Comp. Ex. 16 | Additive B | 11.2 | B | 8.5 | D | 45 | C | 34 | B |
| Comp. Ex. 17 | Additive C | 11.2 | B | 8.5 | D | 45 | C | 34 | B |
| Comp. Ex. 18 | Additive D | 19.7 | D | 2.2 | A | 81 | B | 15 | C |
| | 0.80% used | | | | | | | | |

The amount of additive used was 0.60 percent by mass in solid parts of the total mass of the binder (cement + silica fume).
Note:
¹⁾Additive A-2-2 was used in the reference concrete.
²⁾The compressive strength of the reference concrete with an age of 28 days was 153 N/mm².
³⁾The amount of autogenous shrinkage of the reference concrete was 773 μm.

It has been confirmed that by using a cement additive according to the present invention good results for concrete viscosity, air entrainment properties, strength properties and autogenous shrinkage reducing properties were obtained with water/binder ratios in the region of 15 to 25 percent. In particular, regarding the autogenous shrinkage reducing properties, when comparing the present Examples with the Comparative Examples 4, 5, 10, 11, 16 and 17, it has been possible to confirm an increase of the autogenous shrinkage reducing effect by the combined use of a copolymer and an ether compound according to the present invention.

### INDUSTRIAL APPLICABILITY

The cement dispersant according to the present invention, at low added amounts, improves the handling of cement during operations and significantly reduces autogenous shrinkage of high strength concrete without resulting in a decrease in the strength properties; thus it can advantageously be used in the high strength area, i.e., in concrete with extremely low water/binder ratios.

1. A cement additive comprising polycarboxylate copolymers (compound A) and ether compounds (compound B) as indispensable components: wherein, said compound A is the polycarboxylate copolymer A-1 comprising an unsaturated carboxylate monomer (I) represented by formula (1), a polyoxyalkylene adduct monomer (II) which has an unsaturated group and is represented by formula (3), and a polyalkyleneimine monomer (III) which has an unsaturated group and is represented by formula (5) as indispensable constituent units, and wherein said compound B is an ether compound which has an oxyalkylene group and is represented by formula (6); 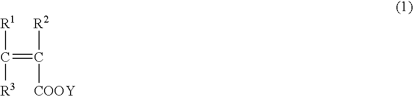
wherein, R¹, R² and R³ each independently represent hydrogen, a methyl group or a —(CH₂) p COOX group, Y and X each independently represent hydrogen, an alkali metal, an alkaline earth metal, ammonium, alkyl ammonium or an alkyl group having 1 to 30 carbon atoms, p is an integer of 0 to 2;
R⁹—O-(A¹)n¹-(R¹⁰O)u²-R¹¹ (3)
wherein, R⁹ represents an alkenyl group having 2 to 5 carbon atoms, A¹ represents an alkylene group having 1 to 4 carbon atoms, n is a number of 0 to 30, R¹⁰O represents an oxyalkylene group having 2 to 3 carbon atoms, u² represents the average addition mol number of the oxyalkylene group (R¹⁰O), which is a number of 1 to 100, R¹¹ represents hydrogen or an alkyl group having 1 to 4 carbon atoms,
R¹⁷—O-(A³)n³-(A⁴)n⁴(R¹⁸O)u⁴-R¹⁹ (5)
wherein, R¹⁷ represents an alkenyl group having 2 to 5 carbon atoms, A³ represents an alkylene group having 1 to 4 carbon atoms, n³-is an integer of 0 to 2, A⁴ represents an alkyleneimine group having 2 to 4 carbon atoms, n⁴ is 1 to 30, R¹⁸O represents an oxyalkylene group having 2 to 3 carbon atoms, u⁴ represents the average addition mol number of the oxyalkylene group (R¹⁸O), which is 1 to 100, R¹⁹ represents hydrogen or an alkyl group having 1 to 4 carbon atoms;
R²⁰O(R²¹O)n⁵H (6)
wherein, R²⁰ represents hydrogen or an alkyl group having 1 to 8 carbon atoms, R²¹O represents an oxyalkylene group having 2 to 3 carbon atoms, n⁵ represents the average addition mol number of the oxyalkylene group (R²¹O), which is a number of 1 to 10.

2. The cement additive according to claim 1, wherein the polycarboxylate copolymers (compound A) further comprise polycarboxylate copolymer A-2 which comprises an unsaturated carboxylate monomer (I) represented by formula (1), a polyoxyalkylene adduct monomer (II) which has an unsaturated group and is represented by formula (3) as an indispensable constituent unit.

3. The cement additive according to claim 2, wherein the mixing ratio of copolymer A-1 and copolymer A-2 in the polycarboxylate copolymer (compound A) is A-1:A-2=100-50:0-50 percent by mass.

4. The cement additive according to claim 2, wherein the amount of the unsaturated carboxylate monomer (I) which is an indispensable constituent unit of copolymers A-1 and A-2 is, in each copolymer, 15 to 50 percent by mass.

5. The cement additive according to any one of claims 1 to 4, wherein the mixing ratio of compounds A and B is compound A:compound B=60-95:40-5 percent by mass.

6. The cement additive according to claim 2, wherein the respective average molecular weight of copolymer A-1 and copolymer A-2 is 5,000 to 50,000.

7. (canceled)

8. The cement additive according to any one of claims 1 to 4, wherein, in compound B represented by formula (6), R²⁰ is hydrogen or an alkyl group having 2 to 4 carbon atoms, with the proviso that, when R²⁰ is hydrogen, R²¹O is propylene oxide, n⁵ is 2 to 9, and when R²⁰ is an alkyl group having 2 to 4 carbon atoms, R²¹O is ethylene oxide and n⁵ is 1 to 4, or R²¹O is propylene oxide and n⁵ is 2 to 9, or R²¹O is a mixture of ethylene oxide and propylene oxide, while n⁵ is 2 to 9.

9. A cement composition comprising water, a binder and a cement additive according to any one of claims 1 to 4, wherein the water/binder ratio is 30 percent or less, and wherein the binder is cement or a mixture of cement and fine hydraulic powder, and the added amount of said cement additive is 0.1 percent to 1.5 percent of the binder mass.
